(19) United States
(12) Patent Application Publication
(10) Pub. No.: US 2022/0306036 A1
(43) Pub. Date: Sep. 29, 2022

(54) OCCUPANT PROTECTION DEVICE

(71) Applicant: TOYODA GOSEI CO., LTD., Kiyosu-shi (JP)

(72) Inventors: Kazuhito KOBAYASHI, Kiyosu-shi (JP); Minoru ONO, Kiyosu-shi (JP)

(21) Appl. No.: 17/693,827

(22) Filed: Mar. 14, 2022

(30) Foreign Application Priority Data
Mar. 26, 2021 (JP) 2021-054266

(51) Int. Cl. B60R 21/206; B60R 21/217; B60R 21/215

(52) U.S. Cl. CPC B60R 21/206; B60R 21/2176; B60R 21/215; B60R 2021/2173; B60R 2021/0051

(57) ABSTRACT

An occupant protection device of the present embodiment includes a lower panel and an airbag device disposed on a front side of a lower end portion of the lower panel with a gap. The airbag device includes an airbag that is deployed and inflated so as to rise from a lower side of the lower end portion of the lower panel to the side of a back surface, as a design surface, of the lower panel to protect the knee of the occupant when inflation gas flows in, and a blocking member that rotates backward and blocks the gap when the airbag is inflated. A contact surface portion which is contact with the blocking member that rotates backward is formed on the lower end portion of the lower panel. The contact surface is formed on the lower side of a flange portion that extends forward from a bent portion.

### CROSS-REFERENCE TO RELATED APPLICATIONS

The present application claims the benefit of priority of Japanese Patent Application No. 2021-054266, filed on Mar. 26, 2021, the content of which is incorporated herein by reference.

### TECHNICAL FIELD

The present invention relates to an occupant protection device including an airbag that inflates to protect a knee of an occupant on a front side of a lower end portion of a lower panel disposed on a front side of the knee of the seated occupant.

### BACKGROUND ART

In the related art, this type of occupant protection device includes a lower panel disposed on a front side of a knee of a seated occupant, and an airbag device disposed on a front side of a lower end portion of the lower panel (see, for example, JP-A-2016-222201). The airbag device includes an airbag that is deployed and inflated so as to rise from the lower end portion of the lower panel to a back surface side of the lower panel to protect the knee of the occupant when inflation gas flows in; an inflator that supplies the inflation gas to the airbag; and a case that accommodates the folded airbag and the inflator and has a protrusion opening that causes the airbag during inflation to protrude toward a lower end side.

### SUMMARY OF INVENTION

However, in the occupant protection device in the related art, when the airbag is inflated, the airbag is deployed and inflated so as to pass a lower side of the lower end portion of the lower panel and rise to the back surface side of the lower panel, so that there was a concern that the inflated airbag may enter a gap between the lower end portion of the lower panel and the airbag device, or that the inflated airbag may get caught in the lower end portion of the lower panel and cause damage to the lower panel. The gap between the lower end portion of the lower panel and the airbag device is generated under the situation that the lower panel and the airbag device are connected to separate instrument panel hoses on a body side, and the lower panel is disposed as a large-sized component made of a synthetic resin that is more flexible than a case and the like, which are made of sheet metal, of the airbag device, so that it is difficult to dispose the lower end portion of the lower panel and the airbag device without a gap or a gap is always generated between the lower end portion of the lower panel and the airbag device due to an assembly error.

The present embodiment solves the above problem, and an object of the present embodiment is to provide an occupant protection device capable of deploying and inflating an airbag without any problem even in an operation in which the airbag during inflation rises from a lower side of a lower end portion of a lower panel to a back surface side of the lower panel.

An occupant protection device according to a first embodiment comprising:

a lower panel disposed on a front side of a knee of a seated occupant; and

an airbag device disposed on a front side of a lower end portion of the lower panel, in which

the airbag device includes:
an airbag that is deployed and inflated so as to rise from a lower side of the lower end portion of the lower panel to a back surface side of the lower panel to protect the knee of the occupant when inflation gas flows in;
an inflator that supplies the inflation gas to the airbag;
a case that accommodates the folded airbag and the inflator and has a protrusion opening that causes the airbag during inflation to protrude toward a lower end side; and
an airbag cover that has a door portion covering the protrusion opening and pushed and opened by the airbag during the inflation and is held by the case, wherein

the airbag device includes a blocking member that is disposed on an outer periphery on a back portion side of the lower end side of the airbag device and that rotates a tip end on a front portion side backward with a back portion side as a center of rotation by a pressing force of the inflated airbag and blocks a gap between the lower end portion of the lower panel and the airbag device,

the lower end portion of the lower panel includes:
a vicinity of a lower end of a vertical wall portion that extends obliquely forward and downward with a back surface side as a design surface; and
a flange portion that extends forward from a bent portion disposed at the lower end of the vertical wall portion, and

an area on a lower surface side of the flange portion from a front edge of the flange portion to the bent portion is configured as a contact surface portion that contacts the rotating blocking member.

In the occupant protection device according to the present embodiment, during the inflation of the airbag, the door portion of the airbag cover is pushed and opened by the inflated airbag to open the protrusion opening of the case, and then the airbag is deployed and inflated from the protrusion opening of the case so as to rise from the lower side of the lower end portion of the lower panel to the back surface side of the lower panel. At this time, since the blocking member disposed on the outer periphery on the back portion side of the lower end side of the airbag device rotates the tip end on the front portion side backward with the back portion side as the center of rotation and blocks the gap between the lower end portion of the lower panel and the airbag device, the airbag that is deployed and inflated rises from a lower end portion side to the back surface side of the lower panel without entering the gap between the lower end portion of the lower panel and the airbag device, and is disposed on the front side of the knee of the occupant, and can receive and protect the knee of the occupant moving forward. Further, the contact surface portion on which the blocking member that rotates backward when blocking the gap is an area on the lower surface side of the flange portion extending forward from the bent portion at the lower end of the vertical wall portion having the back surface side as the design surface, and is not a lower end surface of the vertical wall portion itself forming the design surface, and is a wide surface along a front-back direction facing a rotation direction of the blocking member that rotates backward so as to be orthogonal to the rotation direction. Therefore, even if the blocking member is rapidly rotated by the pressing force of the airbag that is deployed and inflated, the blocking member can be received over an entire area of the contact surface portion having a wide area such that a lower end side of the vertical wall portion is thickened, and even if kinetic energy (impact force) of the rotating blocking member is large, the impact force can be dispersed and received by the contact surface portion having the wide area, and as a result, damage to the flange portion itself or the lower end portion of the lower panel in the vicinity of the lower end of the vertical wall portion forming the design surface due to the blocking member can be prevented.

Therefore, in the occupant protection device according to the present embodiment, even in an operation in which the airbag during the inflation rises from the lower side of the lower end portion of the lower panel to the back surface side of the lower panel, the airbag can be deployed and inflated smoothly without any problem, that is, without damaging the lower panel and without entering the gap between the lower panel and the airbag device.

In addition, in the occupant protection device according to the present embodiment, the blocking member may be formed by the door portion that is pushed by the airbag during the inflation and rotates backward and opens, or may be formed by, when the door portion is disposed on the airbag cover so as to be pushed by the airbag during the inflation and rotate and open in a direction other than a back side, a flexible flap member that is held by the case in which a rotating tip end side is disposed on a lower surface side of the folded airbag, and an original portion side is disposed on a back surface side of the folded airbag.

Then, when the blocking member is formed by the door portion, the airbag cover may be provided with door portions on the opening cover wall portion that covers the protrusion opening of the case that are pushed by the airbag during the inflation and opened on front and back sides by breaking a prearranged breakable portion disposed at peripheral edges of the door portions.

In the door portions that open on the front and back sides, the door portion that opens to the back side may be used as the blocking member.

In such a configuration, the door portions that block the protrusion opening of the case are door portions of double doors that open on the front and back sides. As compared with a single door portion that blocks the gap between the airbag device and the lower end portion of the lower panel and covers the protrusion opening of the case, a rotational moment at the time of opening can be reduced, and the impact force at the time of contacting the contact surface portion can be reduced.

In this case, it is desirable that the prearranged breakable portion is formed by intermittently disposing slits penetrating front and rear sides.

In such a configuration, as compared with a case where the prearranged breakable portion is formed from a recessed groove, the prearranged breakable portion can be easily broken, and a reaction force of the airbag cover at the time of breakage, that is, a reaction force that raises the case by a reaction after the case is pulled down until immediately before the breakage and immediately after the breakage, is reduced, it is difficult to increase arrangement positions of the case and the protrusion opening of the case, it is possible to prevent interference with the lower end portion of the lower panel when the airbag that is deployed and inflated through the protrusion opening of the case passes the lower side of the lower end portion of the lower panel, and it is possible to smoothly raise the airbag from the lower side of the lower end portion of the lower panel to the back surface side of the lower panel.

### BRIEF DESCRIPTION OF DRAWINGS

FIG. 1 is a schematic vertical cross-sectional view of an occupant protection device according to an embodiment of the present embodiment.

FIG. 2 is a schematic front view of the occupant protection device according to the embodiment.

FIG. 3 is a bottom view of an airbag device of the occupant protection device according to the embodiment.

FIG. 4 is a schematic cross-sectional view of the airbag device according to the embodiment, which corresponds to an IV-IV portion of FIG. 3.

FIG. 5 is a bottom view of an airbag cover according to the embodiment.

FIG. 6 is a plan view of the airbag cover according to the embodiment.

FIGS. 7A to 7C are partially enlarged bottom views of the airbag cover according to the embodiment.

FIGS. 8A and 8B are schematic enlarged vertical cross-sectional views of the occupant protection device according to the embodiment, showing states before operation and during the operation.

FIG. 9 is a schematic vertical cross-sectional view of an occupant protection device according to a modified example of the embodiment.

FIG. 10 is a schematic vertical cross-sectional view of the occupant protection device during the operation according to the modified example shown in FIG. 9.

### DESCRIPTION OF EMBODIMENTS

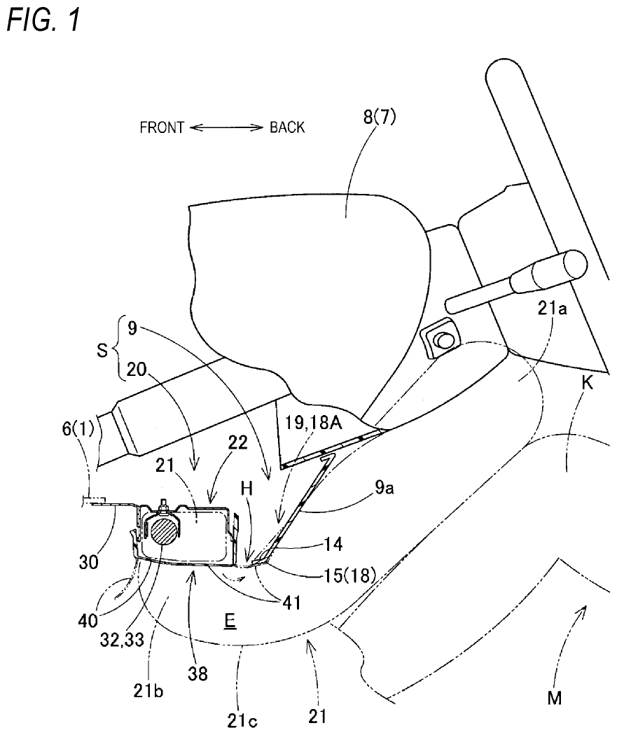

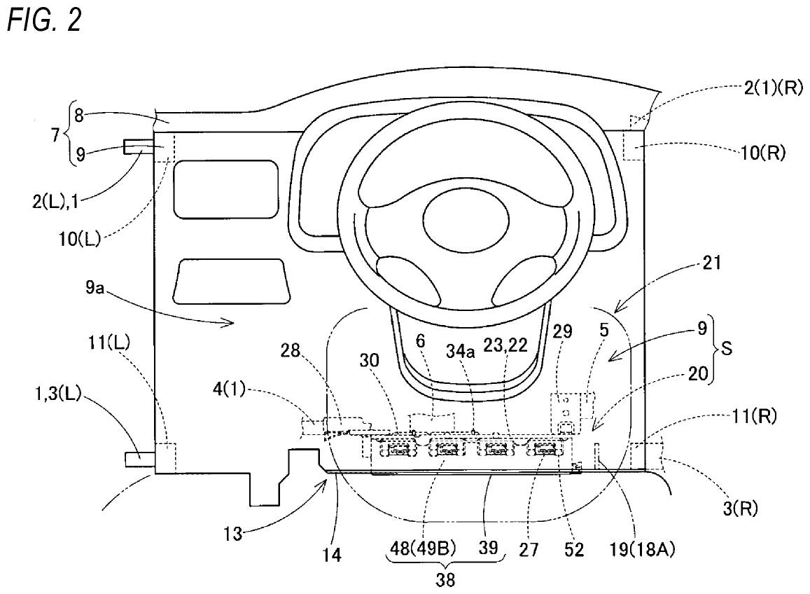

Hereinafter, an embodiment of the present invention will be described with reference to the drawings. As shown in FIGS. 1 and 2, an occupant protection device S according to the embodiment includes a lower panel 9 of an instrument panel 7 disposed on a front side of a knee K of an occupant (specifically, a driver) M seated on a driver seat (not shown), and an airbag device 20 disposed on a front side of a lower end portion 13 of the lower panel 9.

The instrument panel 7 disposed on a front side of the seated occupant M includes an upper panel 8 on an upper side and the lower panel 9 on a lower side, and the occupant protection device S according to the embodiment includes the lower panel 9 on the lower side of the instrument panel 7 and the airbag device 20 as components. The lower panel 9 is made of a synthetic resin, such as polypropylene, formed by injection molding or the like, and has attachment portions 10 (L, R), 11 (L, R) connected to brackets 2 (L, R), 3 (L, R) connected to an instrument panel hose side (not shown) on a body 1 side of a vehicle on peripheral edges. The attachment portions 10 (L, R), 11 (L, R) are attached to the brackets 2 (L, R), 3 (L, R) with a bolt, a nut, or the like, and the lower panel 9 is disposed on the front side of the knee K of the seated occupant M. A back surface 9a of the lower panel 9 forms a design surface disposed on an occupant M side.

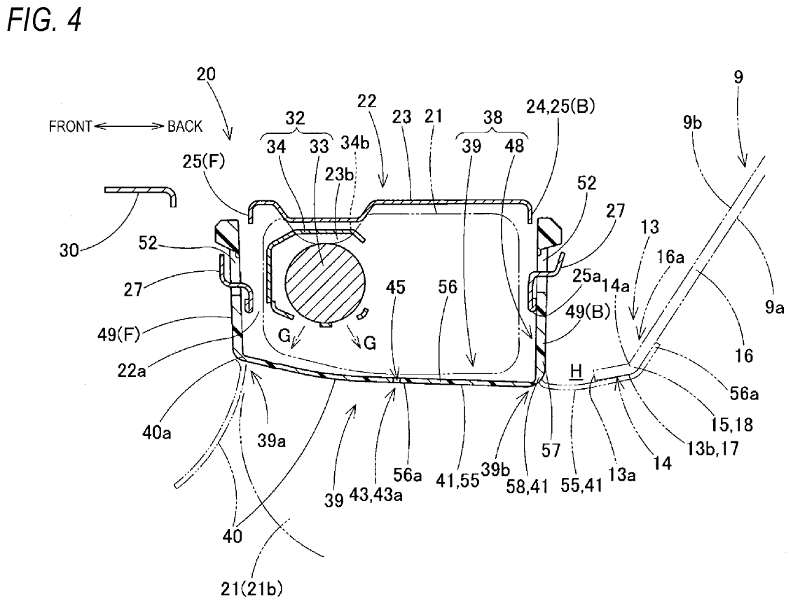

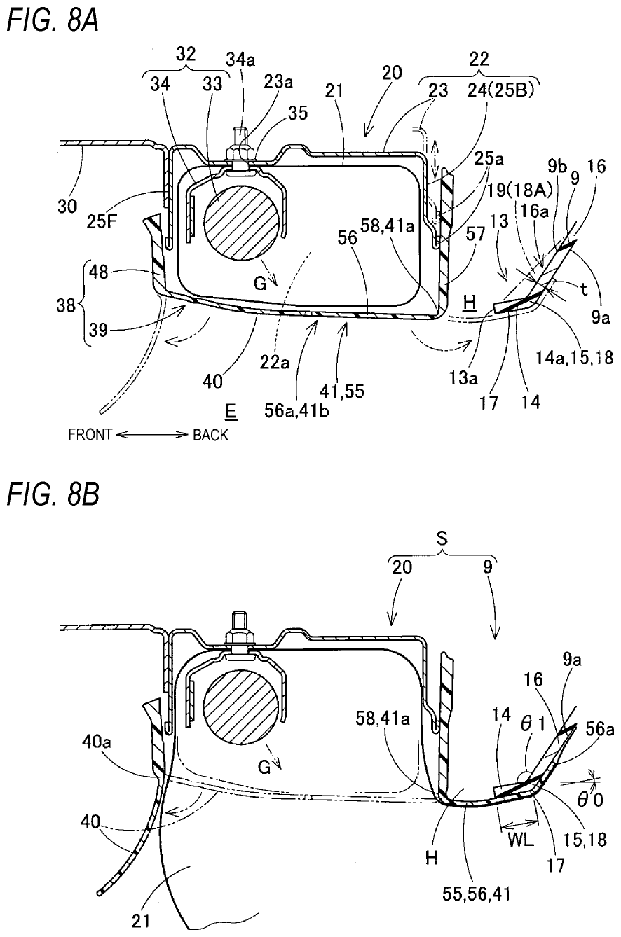

As shown in FIGS. 4, 8A, and 8B, the lower end portion 13 of the lower panel 9 is configured to include a vicinity of a lower end 16a of a vertical wall portion 16 that extends obliquely forward and downward with a back surface 9a side as the design surface, and a flange portion 14 that extends forward from a bent portion 15 disposed at the lower end 16a of the vertical wall portion 16. Then, an area on a lower surface 13b side of the lower end portion 13 from a front edge 13a of the flange portion 14 (also a front edge of the lower end portion 13 of the lower panel 9) to the bent portion 15 serves as a contact surface portion 17 that contacts a door portion 41 when the door portion 41 of an airbag cover 38, which will be described later, of the airbag device 20 rotates backward and opens.

On a lower side of the lower end portion 13 of the lower panel 9, only a space E for feet of the occupant M to enter is formed between the lower end portion 13 and a floor in an vehicle interior. An airbag 21, which will be described later, of the airbag device 20 is deployed and inflated in the space E in the vicinity of an area directly below the lower end portion 13 (in an illustrated example, since the occupant M is the driver, although a brake pedal or the like (not shown) is disposed, the airbag 21 is deployed and inflated in the space E in the vicinity of the area directly below the lower end portion 13 above the pedal and the like).

The lower end portion 13 of the lower panel 9 is provided with the bent portion 15 that bends in an L shape at a portion where the flange portion 14 and the vertical wall portion 16 intersect, even if a thickness is substantially the same. The bent portion 15 also functions as a reinforcing portion 18 for increasing rigidity so that it is possible to prevent the lower end portion 13 from damage such as deformation and cracking when the bent portion 15 contacts the door portion 41 that rotates backward and opens.

In the case of the embodiment, in the lower panel 9, a thickness t of the lower end portion 13 is about 2.8 mm, a length dimension WL of the flange portion 14 in a front-back direction is about 15 mm, an inclination angle θ0 of the flange portion 14 from a horizontal direction is about 40°, and an intersection angle θ1 of the flange portion 14 and the vertical wall portion 16 is about 140° (see FIGS. 8A and 8B).

Then, as shown in FIGS. 1 to 4, 8A and 8B, the airbag device 20 is configured such that a case 22 made of sheet metal, which holds the airbag cover 38 and the like, which will be described later, is connected to and held by brackets 4, 5, and 6 connected to an instrument panel hose (not shown) on the body 1 side by using attachment bracket portions 28, 29, and 30. Therefore, the lower panel 9 and the airbag device 20 are connected to separate brackets 2, 3, 4, 5, and 6 connected to instrument panel hoses on the body side, and the lower panel 9 is disposed as a large-sized component made of a synthetic resin that is more flexible than the case 22 and the like, which are made of the sheet metal, of the airbag device 20, so that a gap H is generated between the lower panel 9 and the airbag device 20 due to an assembly error. In the case of the embodiment, the front edge 13a of the lower end portion 13 of the lower panel 9 is disposed on a back side of a back edge 39b of an opening cover wall portion 39 of the airbag cover 38, which will be described later, of the airbag device 20, and the gap H having an opening width of about 5 mm in the front-back direction is disposed between the front edge 13a and the back edge 39b.

The lower surface 13b (contact surface portion 17) side of the front edge 13a of the lower panel 9 is slightly higher than the back edge 39b, but the opening cover wall portion 39 of the airbag cover 38 of the airbag device 20 and the lower surface 13b side of the front edge 13a are set to have substantially the same height so that the opening cover wall portion 39 is difficult to be seen from a back side.

The airbag device 20 includes the airbag 21, an inflator 32 that supplies inflation gas to the airbag 21, a case 22 that accommodates and holds the airbag 21 and the inflator 32, and the airbag cover 38 that covers a protrusion opening 22a of the airbag 21 in the case 22 and is held by the case 22.

The case 22 is made of the sheet metal, and has a substantially rectangular protrusion opening 22a extending in a left-right direction on a lower end side. The case 22 includes a base wall portion 23 of a substantially rectangular plate shape that faces the protrusion opening 22a in an upper-lower direction, and a cylindrical wall portion 24 of a substantially square cylinder shape that extends downward from a peripheral edge of the base wall portion 23. The attachment bracket portions 28, 29, and 30 connected, with a bolt, a nut, or the like, to the brackets 4, 5, and 6 that are connected to the instrument panel hose (not shown) on the body 1 side, are disposed on the case 22. By connecting the attachment bracket portions 28, 29, and 30 to the brackets 4, 5, and 6, the airbag device 20 is disposed in front of the lower end portion 13 of the lower panel 9.

A plurality of attachment holes 23a through which bolts 34a of the inflator 32 are inserted are formed in the base wall portion 23. A support protrusion 23b is disposed on the base wall portion 23 that is pressed against a main body 33 of the inflator 32 when the bolt 34a is fastened, to strengthen holding of the main body 33.

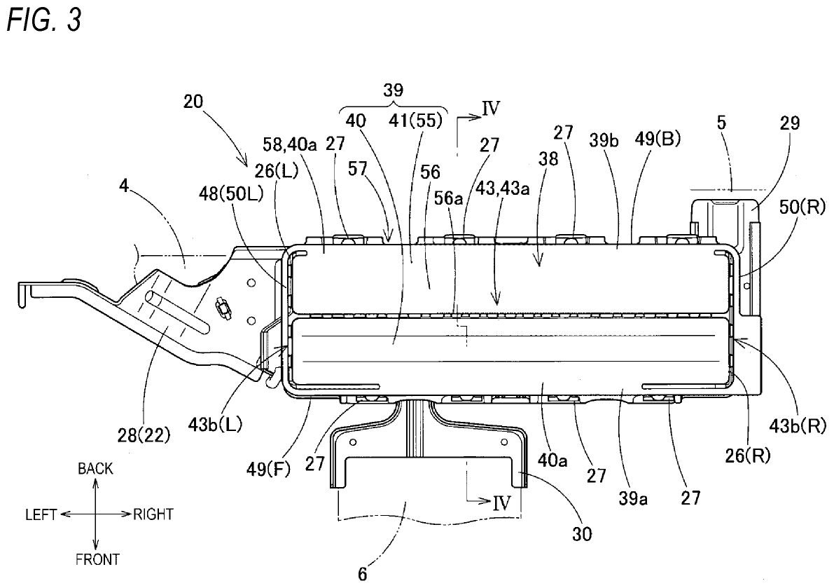

The cylindrical wall portion 24 includes facing wall portions 25 (F, B) facing each other in the front-back direction and facing wall portions 26 (L, R) (see FIG. 3) facing each other in the left-right direction, and a plurality of locking hooks 27 for holding the airbag cover 38 are disposed in the facing wall portions 25 (F, B) facing each other in the front-back direction.

The airbag 21 is held by the base wall portion 23 of the case 22 by using the inflator 32 attached to the base wall portion 23 of the case 22 with the bolt 34a and a nut 35, and is folded and accommodated in the case 22. Then, inflation gas G discharged from the main body 33 of the inflator 32 during operation flows in the airbag 21, and the airbag 21 is deployed and inflated so as to rise from the lower side of the lower end portion 13 of the lower panel 9 to the back surface 9a side to protect the knee K of the occupant M. In the airbag 21 at the time of completion of inflation, an upper portion 21a side is disposed in front of the knee K of the occupant M, and an inversion portion 21c (see a two-dot chain line in FIG. 1) that protrudes downward from the case 22 and that is inverted upward is disposed on a lower portion 21b side.

The inflator 32 includes the substantially columnar main body 33 that discharges the inflation gas G during the operation, and a cylindrical retainer 34 that surrounds the main body 33. A plurality of bolts 34a protruding upward are disposed on the retainer 34. If each bolt 34a is passed through the attachment hole 23a of the base wall portion 23 in the case 22 from a lower surface side upward with the main body 33 covered, and the nut 35 is fastened to the bolt 34a, the support protrusion 23b of the base wall portion 23 is pressed against the main body 33 via an insertion hole 34b of the retainer 34, the retainer 34 is connected to the base wall portion 23 together with the main body 33, and the inflator 32 is connected to and held by the base wall portion 23 of the case 22. The inflator 32 is accommodated in the airbag 21 with the bolt 34a protruding. When the inflator 32 is connected to the base wall portion 23, the airbag 21 is also connected to and held by the base wall portion 23 of the case 22 by using the inflator 32.

As shown in FIGS. 3 to 8B, the airbag cover 38 is made of a synthetic resin such as an olefin-based thermoplastic elastomer, and includes the opening cover wall portion 39 that covers the protrusion opening 22a of the case 22, and a connecting wall portion 48 of a square cylinder shape that extends upward from a peripheral edge of the opening cover wall portion 39.

The connecting wall portion 48 includes facing wall portions 49 (F, B) facing each other in the front-back direction and facing wall portions 50 (L, R) facing each other in the left-right direction, and a plurality of locking holes 52 for locking of the locking hooks 27 of the case 22 are disposed in the facing wall portions 49 (F, B) facing each other in the front-back direction.

The opening cover wall portion 39 is provided with door portions 40, 41 that are pushed by the airbag 21 during the inflation and opened to front and back sides. The door portions 40, 41 are configured such that a prearranged breakable portion 43 is disposed at peripheral edges of the door portion 40, 41, and when the door portions 40, 41 are pushed by the airbag 21, the prearranged breakable portion 43 is broken, and the door portions 40, 41 are opened to the front and back sides as double doors, with hinge portions 40a, 41a disposed at front and back edge sides of the opening cover wall portion 39 as centers of rotation. The prearranged breakable portion 43 has a substantially H shape including a horizontal bar portion 43a disposed along the left-right direction at a central portion of the opening cover wall portion 39 in the front-back direction, and vertical bar portions 43b (L, R) disposed along the front-back direction at left and right ends of the horizontal bar portion 43a. Further, in the case of the embodiment, the prearranged breakable portion 43 is formed by intermittently disposing slits 45 penetrating front and rear sides.

That is, in the case of the embodiment, the prearranged breakable portion 43 is formed of a large number of slits 45 intermittently disposed in a substantially H shape and a large number of connecting portions 46 between the slits 45, and when the door portions 40, 41 are opened, the connecting portions 46 are broken, and the door portions 40, 41 are opened with the hinge portions 40a, 41a disposed in the vicinity of front and back edges 39a, 39b of the opening cover wall portion 39 where the prearranged breakable portion 43 is not disposed, as the centers of rotation.

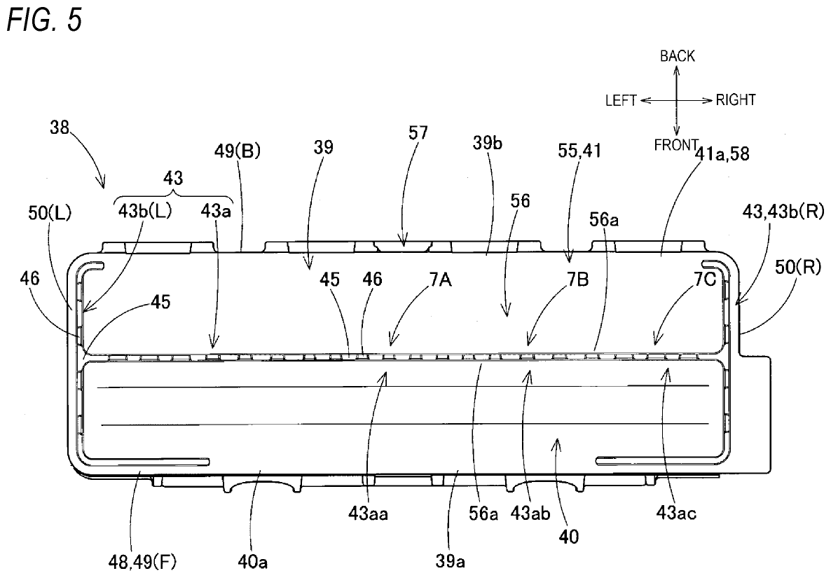

Then, in the case of the embodiment, as shown in FIGS. 5 to 7C, in a portion of the horizontal bar portion 43a of the prearranged breakable portion 43, the connecting portion 46 is disposed such that a front end portion 46a connected to the door portion 40 on a front portion side has a wider width dimension than a back end portion 46b connected to the door portion 41 on a back portion side (a width dimension WF of the front end portion 46a>a width dimension WB of the back end portion 46b). Therefore, when the prearranged breakable portion 43 is broken, a back end portion 46b side of the small width dimension WB where stress concentration is likely to occur is likely to be broken, the door portion 41 that opens to the back side on the occupant M side opens to the back side on the occupant M side as a leading edge 41b with a beautiful breakage surface without the connecting portion 46 remaining.

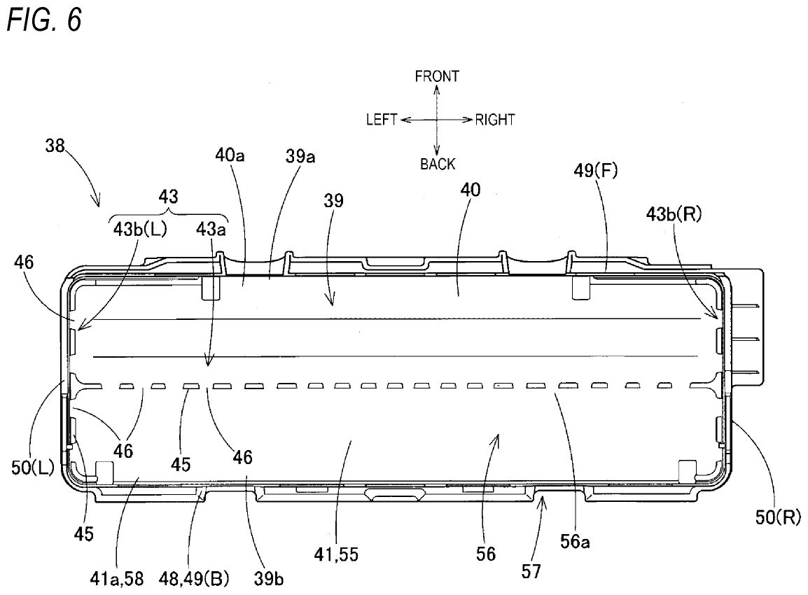

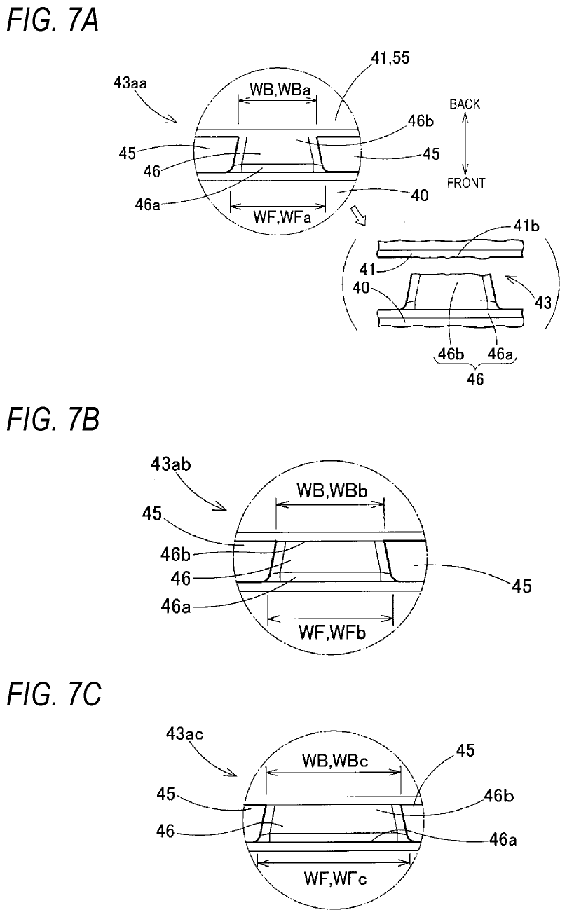

In addition, in the case of the embodiment, as shown in FIGS. 6 to 7C, the connecting portion 46 in the prearranged breakable portion 43 is set such that a center 43aa side in the left-right direction of the horizontal bar portion 43a of the prearranged breakable portion 43 is thin, left and right edges 43ab and 43ac sides are sequentially thickened (width dimension WFa<WFb<WFc, width dimension WBa<WBb<WBc), and when the airbag 21 is inflated, the center 43aa side of the horizontal bar portion 43a serves as a starting point of smooth breakage.

Then, in the embodiment, among the door portions 40, 41 that open to the front and back sides, the door portion 41 that opens to the back side is a blocking member 55 that blocks the gap H between the lower end portion 13 of the lower panel 9 and the airbag device 20.

In the occupant protection device S of the embodiment, if the attachment portions 10 (L, R), 11 (L, R) are attached to the brackets 2 (L, R), 3 (L, R), the lower panel 9 can be mounted in front of the driver seat (not shown), and if the attachment bracket portions 28, 29, 30 are attached to the brackets 4, 5, 6, the assembled airbag device 20 can be mounted on the front side of the lower end portion 13 of the lower panel 9.

In an assembly of the airbag device 20, the retainer 34 of the inflator 32 is accommodated in the airbag 21 in a state in which the bolt 34a protrudes from the airbag 21, the airbag 21 is folded and wrapped with a wrapping material for preventing folding collapse, and the folded airbag 21 is accommodated in the case 22 while the bolt 34a protrudes from the base wall portion 23, and then if the main body 33 of the inflator 32 is inserted into the retainer 34 through the facing wall portion 26L of the case 22 and an insertion hole (not shown) of the airbag 21, and the nut 35 is fastened to the bolt 34a, as described above, the support protrusion 23b of the base wall portion 23 of the case 22 is pressed against the main body 33, the main body 33 is fixed in the retainer 34, the inflator 32 is attached and fixed to the base wall portion 23, and the airbag 21 is also attached to the base wall portion 23, and the inflator 32 and the airbag 21 are accommodated and held in the case 22. Then, when the connecting wall portion 48 of the airbag cover 38 is put on the cylindrical wall portion 24 of the case 22 and the locking hooks 27 of the case 22 are locked to the locking holes 52, the airbag cover 38 is also held by the case 22, and the assembly of the airbag device 20 can be completed. In addition, when the airbag device 20 is mounted on the vehicle, an operation signal line extending from a control device of the vehicle (not shown) is connected to the main body 33 of the inflator 32.

After the occupant protection device S is mounted on the vehicle, if the vehicle collides and the inflator 32 is operated, the inflation gas G discharged from the main body 33 of the inflator 32 flows in the airbag 21, and the airbag 21 is inflated. During the inflation of the airbag 21, since the airbag 21 pushes the opening cover wall portion 39 of the airbag cover 38, the door portions 40, 41 are pushed and opened by breaking the prearranged breakable portion 43 at the peripheral edges of the door portions 40, 41. Then, the protrusion opening 22a of the case 22 is opened, so that the inflated airbag 21 is deployed and inflated so as to rise from the lower side of the lower end portion 13 of the lower panel 9 to the back surface 9a side of the lower panel 9 through the protrusion opening 22a of the case 22 (see the two-dot chain line in FIG. 1, and FIGS. 8A and 8B). At this time, the blocking member 55 formed by the door portion 41 disposed on an outer periphery on a back portion side of a lower end side of the airbag device 20 rotates a tip end 56a on a front portion 56 side backward with a portion 58 (hinge portion 41a) on a back portion 57 side as the center of rotation and blocks the gap H between the lower end portion 13 of the lower panel 9 and the airbag device 20, so that the airbag 21 that is deployed and inflated rises from a lower end portion 13 side to the back surface 9a side of the lower panel 9 without entering the gap H between the lower end portion 13 of the lower panel 9 and the airbag device 20, and is disposed on the front side of the knee K of the occupant M, and can receive and protect the knee K of the occupant M moving forward. Further, the contact surface portion 17 on which the blocking member 55 that rotates backward when blocking the gap H is an area on the lower surface 13b side of the flange portion 14 extending forward from the bent portion 15 at the lower end 16a of the vertical wall portion 16 having the back surface 9a side as the design surface, and is not a lower end surface of the vertical wall portion 16 itself forming the design surface, and is a wide surface along the front-back direction facing a rotation direction of the blocking member 55 that rotates backward so as to be orthogonal to the rotation direction. Therefore, even if the blocking member 55 is rapidly rotated by a pressing force of the airbag 21 that is deployed and inflated, the blocking member 55 can be received over an entire area of the contact surface portion 17 having a wide area such that a lower end 16a side of the vertical wall portion 16 is thickened, and even if kinetic energy (impact force) of the rotating blocking member 55 is large, the impact force can be dispersed and received by the contact surface portion 17 having the wide area, and as a result, damage to the flange portion 14 itself or the lower end portion 13 of the lower panel 9 in the vicinity of the lower end 16a of the vertical wall portion 16 forming the design surface due to the blocking member 55 can be prevented.

Therefore, in the occupant protection device S of the embodiment, even in an operation in which the airbag 21 during the inflation rises from the lower side of the lower end portion 13 of the lower panel 9 to the back surface 9a side of the lower panel 9, the airbag 21 can be deployed and inflated smoothly without any problem, that is, without damaging the lower panel 9 and without entering the gap H between the lower panel 9 and the airbag device 20.

In the embodiment, the lower end portion 13 of the lower panel 9 with which the door portion 41 serving as the blocking member 55 contacts beyond the gap H is located in the vicinity of the lower end 16a of the vertical wall portion 16 beyond the contact surface portion 17 and the bent portion 15, and the bent portion 15 extending continuously in the left-right direction is disposed over an entire area extending in the left-right direction of an area thereof, and the bent portion 15 forms a reinforcing portion 18 that reinforces the flange portion 14, and it is possible to prevent cracking or deformation of the flange portion 14 at the time of interference with the blocking member 55.

In addition, as the reinforcing portion, a triangular plate-shaped rib 19 that straddles the bent portion 15 and connects the flange portion 14 and the vertical wall portion 16 may be provided on a front surface 9b of the lower panel 9, and a reinforcing portion 18A of the flange portion 14 and the contact surface portion 17 may be formed by the rib 19 and the bent portion 15 (see two-dot chain lines in FIGS. 2 and 8A).

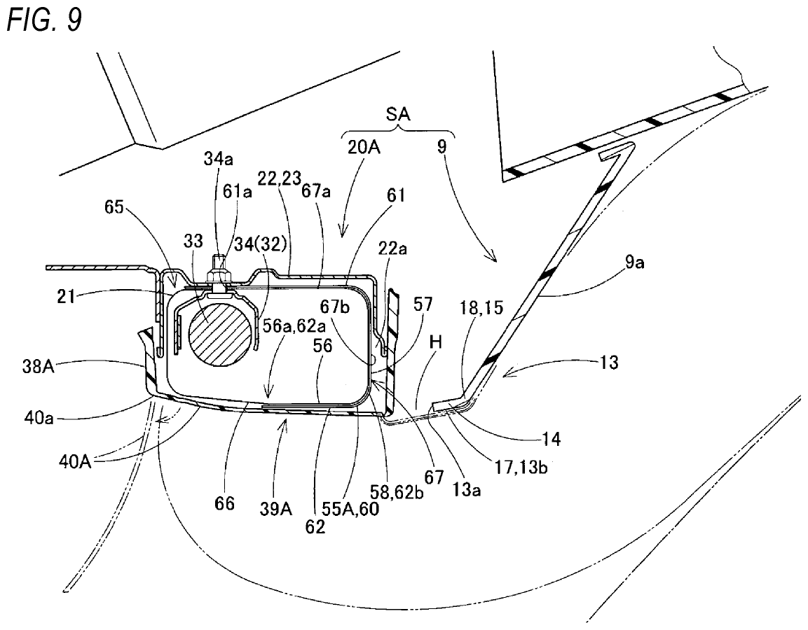

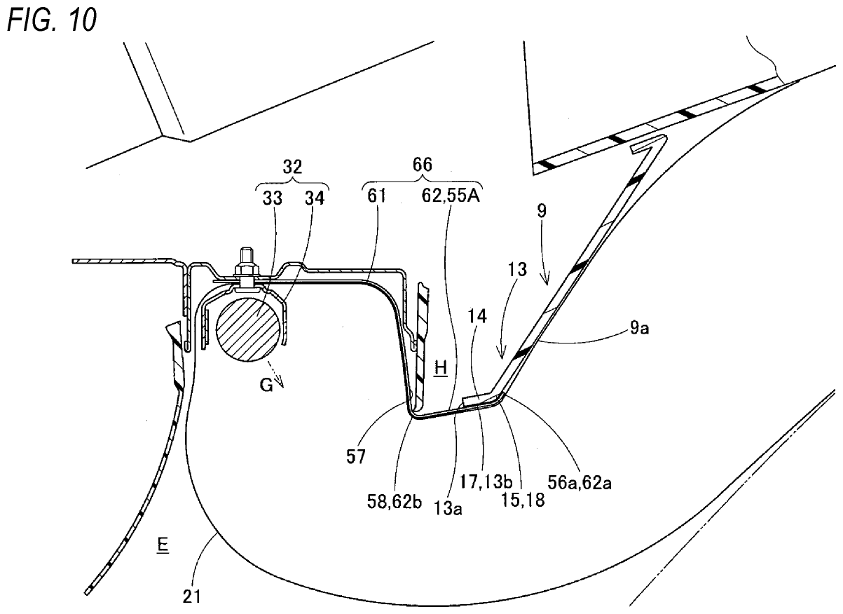

Further, in the occupant protection device S, the blocking member 55 is formed by the door portion 41 itself that is pushed by the airbag 21 during the inflation and rotates backward and opens, but a flap member 60 shown in FIGS. 9 and 10 may serve as a blocking member 55A.

An occupant protection device SA is different from the occupant protection device S of the embodiment in that an opening cover wall portion 39A on an airbag cover 38A that covers the protrusion opening 22a of the case 22 is set to open in a region other than the back side as a door portion 40A that is pushed and opened during the inflation. In the case of the illustrated example, the door portion 40A is pushed by the airbag 21 during the inflation with the hinge portion 40a on a front edge side as the center of rotation, so that the door portion 40A rotates forward and opens, and an entire area of the protrusion opening 22a of the case 22 is opened. Other connecting wall portion 48 of the airbag cover 38A other than the door portion 40A, the airbag 21, the case 22, the inflator 32, and the like have similar configurations as the airbag device 20 of the embodiment.

The flap member 60 as the blocking member 55A is formed of a flexible sheet material made of nonwoven fabric, synthetic resin such as high-density polyethylene or thermoplastic elastomer. The flap member 60 includes a flap main body portion 62 on a tip end side that rotates, and an attachment base portion 61 on an original portion side that is connected to the case 22. The flap main body portion 62 has a configuration in which a tip end 62a (the tip end 56a of the front portion 56) side is disposed forward on a lower surface 66 side of a folded body 65 of the folded airbag 21 to cover an entire back side area on the lower surface 66 side of the folded body 65. The attachment base portion 61 is continuous from a back surface 67b as the back surface side 67 of the folded body 65 to an upper surface 67a, a through hole 61a is locked to the bolt 34a that is fastened to the nut 35 of the inflator 32, and the attachment base portion 61 is connected to and held on the base wall portion 23 of the case 22 using the bolt 34a that is fastened to the case 22 by being fastened with the nut 35.

In the occupant protection device SA, when the inflation gas G from the inflator 32 flows into the airbag 21 and the airbag 21 is inflated, the door portion 40A of the airbag cover 38A is pushed by the airbag 21 and rotates forward and opens, and the flap main body portion 62 of the flap member 60 rotates backward and downward with a vicinity of the back end 62b in the vicinity of the back edge 39b (the portion 58 on the back portion 57 side) of the airbag cover 38A as the center of rotation, blocks the gap H, and contacts the contact surface portion 17 of the lower panel 9. Then, the flap main body portion 62 of the flap member 60 blocks the gap H between the lower end portion 13 of the lower panel 9 and the airbag device 20, so that the airbag 21 that is deployed and inflated rises from the lower end portion 13 side to the back surface 9a side of the lower panel 9 without entering the gap H between the lower end portion 13 of the lower panel 9 and the airbag device 20, and is disposed on the front side of the knee K of the occupant M, and can receive and protect the knee K of the occupant M moving forward. In addition, the flap member 60 as the blocking member 55A rotates backward and contacts the contact surface portion 17 similar as in the embodiment, the contact surface portion 17 is not the lower end surface of the vertical wall portion 16 itself forming the design surface, and is a wide surface along the front-back direction facing a rotation direction of the flap member 60 as the blocking member 55A that rotates backward so as to be orthogonal to the rotation direction similar as in the embodiment, so that even if kinetic energy (impact force) of the rotating flap member 60 as the blocking member 55A is large, the impact force can be dispersed and received by the contact surface portion 17 having the wide area, and as a result, damage to the lower end portion 13 of the lower panel 9 due to the blocking member 55A can be prevented, and a similar action and effect as those of the embodiment can be obtained.

In the embodiment, the airbag cover 38 is provided with the door portions 40, 41 on the opening cover wall portion 39 that covers the protrusion opening 22a of the case 22 that are pushed by the airbag 21 during the inflation and opened on the front and back sides by breaking the prearranged breakable portion 43 disposed at the peripheral edges of the door portions 40, 41. Then, in the door portions that open on the front and back sides, the door portion 41 that opens to the back side is used as the blocking member 55 that blocks the gap H.

Therefore, in the embodiment, the door portions 40, 41 that block the protrusion opening 22a of the case 22 are door portions of double doors that open on the front and back sides. As compared with a single door portion that blocks the gap H between the airbag device 20 and the lower end portion 13 of the lower panel 9 and covers the protrusion opening 22a of the case 22, a rotational moment at the time of opening can be reduced, and the impact force at the time of contacting the contact surface portion 17 can be reduced.

If the rotational moment at the time of opening can be reduced, for example, if the door portion has a length dimension that blocks the gap H and the length dimension in the front-back direction of the door portion is small, the door portion may be configured to block the protrusion opening of the case as a single door portion that opens backward.

Further, in the embodiment, the prearranged breakable portion 43 is formed by intermittently disposing the slits 45 penetrating the front and rear sides.

Therefore, in the embodiment, as compared with a case where the prearranged breakable portion 43 is formed from a recessed groove, the prearranged breakable portion 43 can be easily broken, and a reaction force of the airbag cover 38 at the time of breakage, that is, a reaction force that raises the case 22 by a reaction after the case 22 is pulled down until immediately before the breakage and immediately after the breakage, is reduced, it is difficult to increase arrangement positions of the base wall portion 23 and the protrusion opening 22a of the case 22, it is possible to prevent interference with the lower end portion 13 of the lower panel 9 when the airbag 21 that is deployed and inflated through the protrusion opening 22a of the case 22 passes the lower side of the lower end portion 13 of the lower panel 9, and it is possible to smoothly raise the airbag 21 from the lower side of the lower end portion 13 of the lower panel 9 to the back surface 9a side of the lower panel 9.

If the prearranged breakable portion 43 is not easily broken, a stroke for pulling down the case 22 immediately before the breakage increases, and a reaction immediately after the breakage increases a reaction force that greatly raises the case 22. Then, when the case 22 is greatly raised, an arrangement of the base wall portion 23 holding the airbag 21 greatly deviates upward from the lower end portion 13 of the lower panel 9 (see the two-dot chain line in FIG. 8A), the airbag 21 that goes up from the lower side of the lower end portion 13 of the lower panel 9 is caught by the lower end portion 13, and it becomes difficult to secure smooth deployment and inflation of the airbag 21.

In addition, in the embodiment, the occupant protection device S configured to include the airbag device 20 for knee protection that protects the knee of the occupant in the driver seat and the lower panel 9 in front of the airbag device 20 is described, but an occupant protection device may be configured to include an airbag device for protecting the knee of an occupant in a front passenger seat and a lower panel in front of the airbag device.

What is claimed is:

1. An occupant protection device comprising:
a lower panel disposed on a front side of a knee of a seated occupant; and
an airbag device disposed on a front side of a lower end portion of the lower panel, in which
the airbag device includes:
an airbag that is deployed and inflated so as to rise from a lower side of the lower end portion of the lower panel to a back surface side of the lower panel to protect the knee of the occupant when inflation gas flows in;
an inflator that supplies the inflation gas to the airbag;
a case that accommodates the folded airbag and the inflator and has a protrusion opening that causes the airbag during inflation to protrude toward a lower end side; and
an airbag cover that has a door portion covering the protrusion opening and pushed and opened by the airbag during the inflation and is held by the case, wherein
the airbag device includes a blocking member that is disposed on an outer periphery on a back portion side of the lower end side of the airbag device and that rotates a tip end on a front portion side backward with a back portion side as a center of rotation by a pressing force of the inflated airbag and blocks a gap between the lower end portion of the lower panel and the airbag device,
the lower end portion of the lower panel includes:
a vicinity of a lower end of a vertical wall portion that extends obliquely forward and downward with a back surface side as a design surface; and
a flange portion that extends forward from a bent portion disposed at the lower end of the vertical wall portion, and
an area on a lower surface side of the flange portion from a front edge of the flange portion to the bent portion is configured as a contact surface portion that contacts the rotating blocking member.

2. The occupant protection device according to claim 1, wherein
the door portion is disposed on the airbag cover so as to be pushed by the airbag during the inflation and rotate and open in a direction other than a back side, and
the blocking member is formed by a flexible flap member that is held by the case in which a rotating tip end side is disposed on a lower surface side of the folded airbag, and an original portion side is disposed on a back surface side of the folded airbag.

3. The occupant protection device according to claim 1, wherein the blocking member is formed by the door portion that is pushed by the airbag during the inflation and rotates backward and opens.

4. The occupant protection device according to claim 3, wherein
the airbag cover includes door portions on the opening cover wall portion that covers the protrusion opening of the case that are pushed by the airbag during the inflation and opened on front and back sides by breaking a prearranged breakable portion disposed at peripheral edges of the door portions, and
in the door portions that open on the front and back sides, the door portion that opens to the back side is used as the blocking member.

5. The occupant protection device according to claim 4, wherein the prearranged breakable portion is formed by intermittently disposing slits penetrating front and rear sides.
